(19) United States
(12) Patent Application Publication
(10) Pub. No.: US 2025/0056097 A1
(43) Pub. Date: Feb. 13, 2025

(54) SYSTEM AND METHOD FOR STREAM DISTRIBUTION

(71) Applicant: 17LIVE Japan INC., Tokyo (JP)

(72) Inventors: Wei-Kun LU, Taipei City (TW); Yu-Cheng FAN, Taipei City (TW); Chia-Han CHANG, Taipei City (TW); Hung-Kuang TAI, Taipei City (TW)

(21) Appl. No.: 18/765,215

(22) Filed: Jul. 6, 2024

(30) Foreign Application Priority Data
Aug. 10, 2023 (JP) 2023-131450

(51) Int. Cl. H04N 21/4788; H04N 21/2187; H04N 21/24

(52) U.S. Cl. CPC H04N 21/4788; H04N 21/2187; H04N 21/2407

(57) ABSTRACT

The present disclosure relates to a system and a method for stream distribution. The method includes: determining a viewer to be a helper viewer with respect to a content type; determining a distributor to have engaged in the content type in a stream; and suggesting the distributor to invite the viewer into the stream.

### CROSS-REFERENCE TO RELATED APPLICATIONS

This application is based on and claims the benefit of priority from Japanese Patent Application Serial No. 2023-131450 (filed on Aug. 10, 2023), the contents of which are hereby incorporated by reference in their entirety.

### BACKGROUND OF THE DISCLOSURE

### Technical Field

The present disclosure relates to stream distribution and, more particularly, to live stream distribution.

### Description of Related Art

Real time interaction on the Internet, such as live streaming service, has become popular in our daily life. There are various platforms or providers providing the service of live streaming, and the competition is fierce. It is important for a platform to provide its users their desired services.

Taiwan patent application publication TW201832576 discloses a method for actively constructing a real-time interaction group on the Internet.

### SUMMARY OF THE DISCLOSURE

A method according to one embodiment of the present disclosure is a method for stream distribution being executed by one or a plurality of computers, and includes: determining a viewer to be a helper viewer with respect to a content type; determining a distributor to have engaged in the content type in a stream; and suggesting the distributor to invite the viewer into the stream.

A method according to one embodiment of the present disclosure is a method for stream distribution being executed by one or a plurality of computers, and includes: obtaining a first request with a first reward offer to invite a viewer into a first live stream from a first distributor; obtaining a second request with a second reward offer to invite the viewer into a second live stream from a second distributor; transmitting the first request and the second request to the viewer; obtaining a selection result from the viewer; and inviting the viewer into the first live stream or the second live stream according to the selection result.

A system according to one embodiment of the present disclosure is a system for stream distribution that includes one or a plurality of processors, and the one or plurality of computer processors execute a machine-readable instruction to perform: determining a viewer to be a helper viewer with respect to a content type; determining a distributor to have engaged in the content type in a stream; and suggesting the distributor to invite the viewer into the stream.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the interaction DB 330 of FIG. 3.

FIG. 8 is a data structure diagram showing an example of the contribution impact DB 332 of FIG. 3.

FIG. 9 shows an example of data stored in the contribution impact DB 332.

FIG. 10 shows an example of data stored in the contribution impact DB 332.

FIG. 11 is a data structure diagram showing an example of the profile DB 334 of FIG. 3.

FIG. 12 is a data structure diagram showing an example of the confidence score DB 336 of FIG. 3.

FIG. 13 shows an exemplary flow according to some embodiments of the present disclosure.

FIG. 14 shows an exemplary user interface at the distributor side according to some embodiments of the present disclosure.

FIG. 15 shows an exemplary viewer profile page according to some embodiments of the present disclosure.

FIG. 16 shows an exemplary user interface at the viewer side according to some embodiments of the present disclosure.

FIG. 17 shows an exemplary user interface at the distributor side according to some embodiments of the present disclosure.

FIG. 18 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

A distributor (or streamer) on a streaming platform would like to keep good interaction with viewers to achieve higher rewards. However, a new distributor may not know how to interact with viewers. Or, a distributor may not know how to interact with viewers in some areas or topics. Therefore, a method or a system to help the distributor to interact with viewers is desirable.

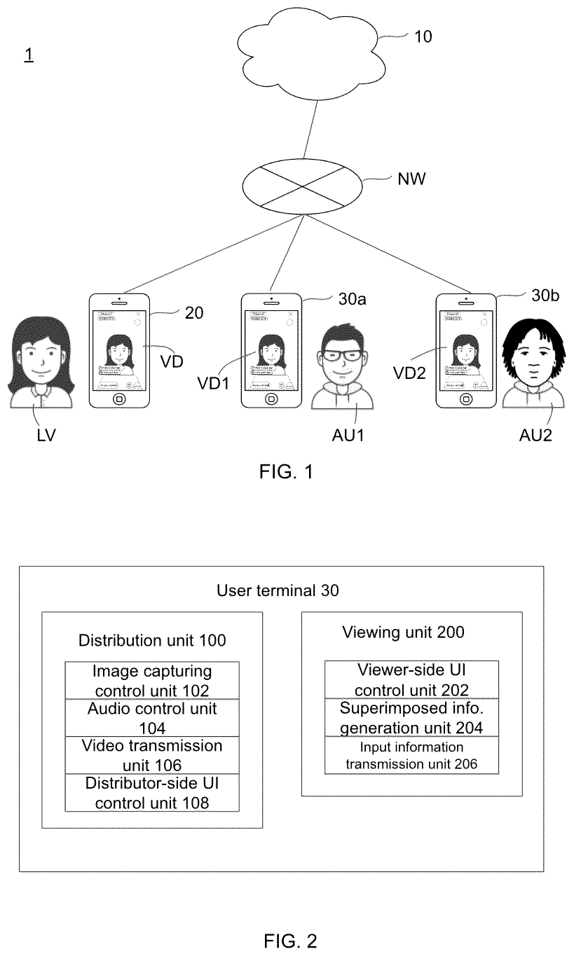

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

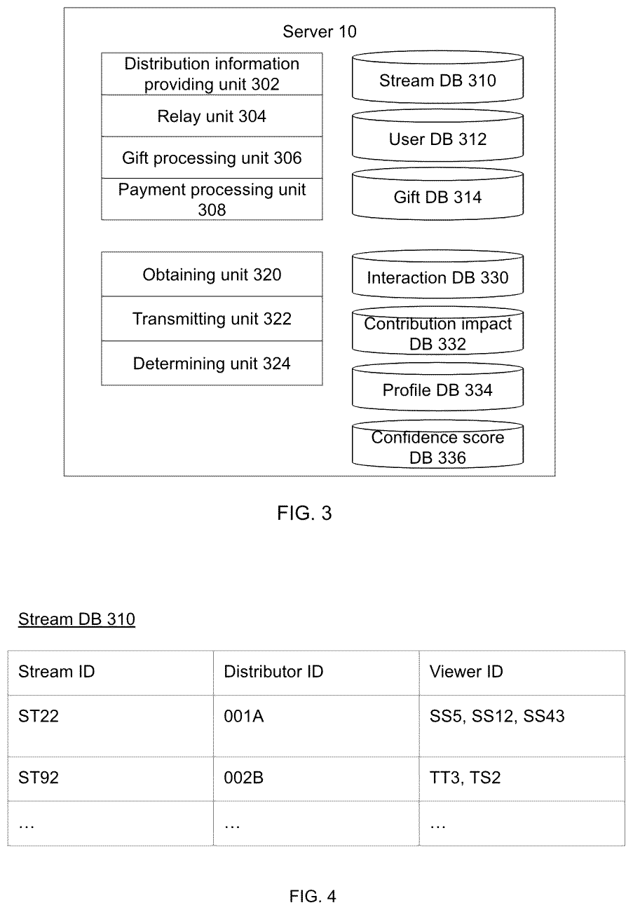

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an obtaining unit 320, a transmitting unit 322, a determining unit 324, an interaction DB 332, a contribution impact DB 332, a profile DB 334, and a confidence score DB 336.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

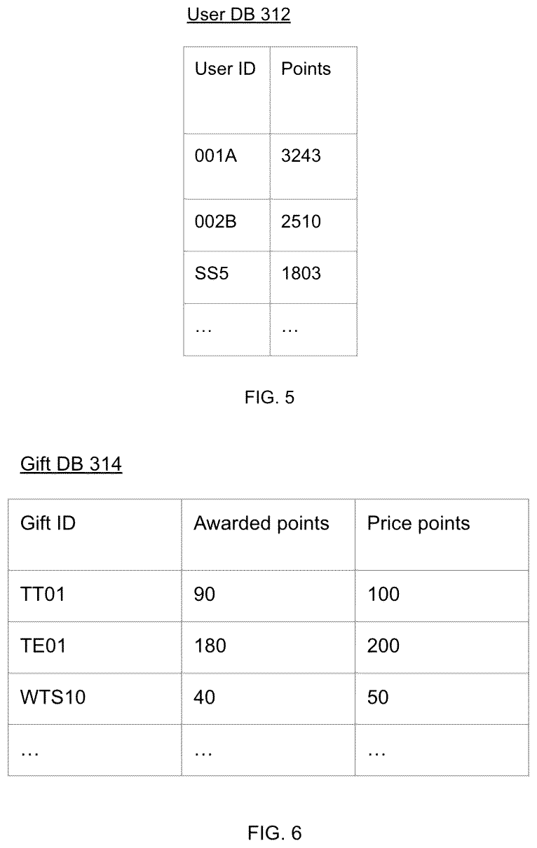

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

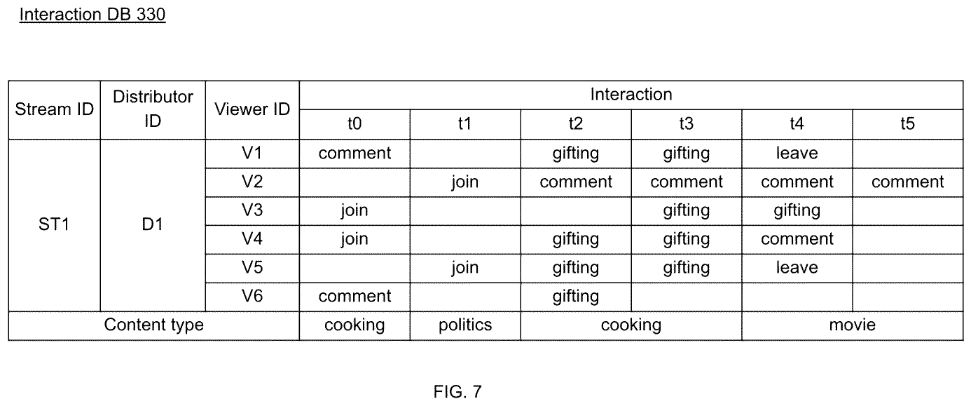

FIG. 7 is a data structure diagram showing an example of the interaction DB 330 of FIG. 3. The interaction DB 330 stores the stream ID, the distributor ID, the viewer ID, the interaction parameters in different timings (or time spans, or time durations), and the content type, in association with each other.

t0 to t5 could be timings, time spans, or time durations. For example, during the duration to, the content type (or the topic engaged by the distributor D1) in the stream ST1 is “cooking”, and viewer V1 performs a comment action in the stream ST1. During the duration t1, viewer V2 joins the stream. During the duration t2, viewer V4 performs a gifting action. During the duration t4, viewer V5 leaves the stream.

In some embodiments, the interaction parameters could be obtained by the obtaining unit 320 from a monitoring unit (not shown) implemented within or outside server 10. In some embodiments, the content type could be detected by a detecting unit (not shown) implemented within or outside server 10. The detecting unit may perform image detection process, sound detection process, comment detection process or motion detection process on the stream content. The content type detection could be performed in a real time manner.

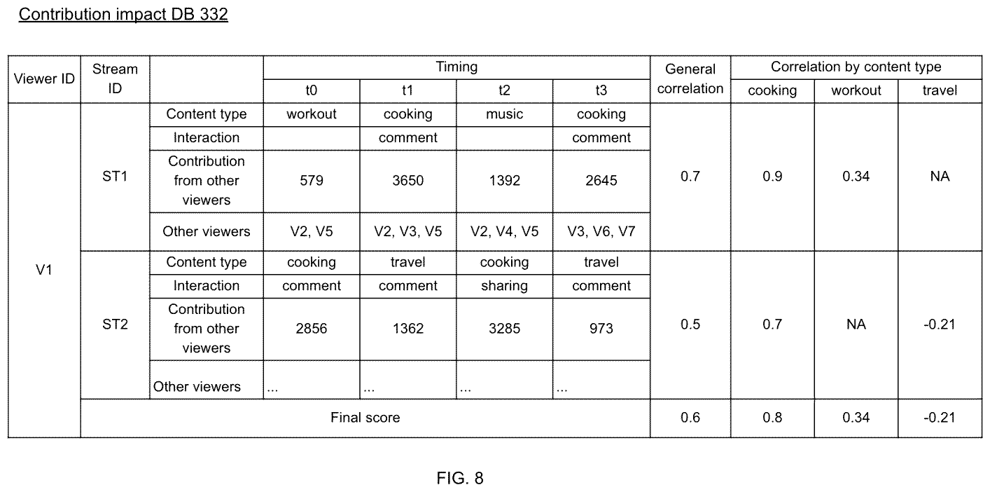

FIG. 8 is a data structure diagram showing an example of the contribution impact DB 332 of FIG. 3. The contribution impact DB 332 stores the viewer ID, the stream ID, the interactions performed by the viewer, the content type of the stream, the contribution from other viewers, other viewers in the same stream, the general correlation value, and the correlation value for each content type, in association with each other.

The contribution from other viewers could be the gift amount or the reward amount contributed to the distributor of the stream, from all viewers except viewer V1, in respective time durations. By removing the contribution of viewer V1, the embodiment could determine viewer V1's impact on other viewers' contribution in a more precise or reliable manner. For example, the bias due to a huge contribution of viewer V1 could be removed. In some embodiments, the contribution value could be calculated according to the interaction parameters (such as gifting action or gifting amount) stored in the interaction DB 330 by the determining unit 324.

The “general correlation” could be the correlation value (or correlation coefficient value) between the interaction of viewer V1 and the contribution from other viewers. In some embodiments, the correlation value indicates the variation trend of the contribution from other viewers with respect to interaction of viewer V1. The calculation could be done with respect to (or based on) all interaction actions of viewer V1 or specific interaction action (such as comment or gifting) of viewer V1. In some embodiments, the correlation value could be normalized. In some embodiments, the correlation value could be between −1 and 1. A positive value means the contribution from other viewers increases with interaction of viewer V1, and a negative value means the contribution from other viewers decreases with interaction of viewer V1.

The “correlation by content type” is similar to the “general correlation”, except that it is calculated for each content type respectively. Therefore, the value of the “correlation by content type” indicates the correlation between the interaction of viewer V1 and the contribution from other viewers under a specific content type.

For example, as shown in FIG. 8, from the data related to stream ST1, viewer V1 has a high correlation value in the [cooking] topic. That indicates viewer V1 has a positive impact on the contribution from other viewers under the topic [cooking]. In other words, when the topic is cooking, viewer V1's interaction (such as comment) could encourage or motivate other viewers to contribute more (such as more gifting) to the distributor. Therefore, viewer V1 may be determined to be a master influencer in the topic [cooking] (by the determining unit 324, for example).

For example, as shown in FIG. 8, from the data related to stream ST2, viewer V1 has a negative correlation value in the [travel] topic. That indicates viewer V1 has a negative impact on the contribution from other viewers under the topic [travel]. In other words, when the topic is travel, viewer V1's interaction (such as comment) may interrupt or prevent other viewers from contributing (such as gifting) to the distributor. Therefore, viewer V1 may be determined to be an unwelcome viewer in the topic [travel].

The final scores show the average values of the “general correlation” and the “correlation by content type” calculated with various streams engaged by viewer V1. In some embodiments, calculations other than “average” may be utilized. In some embodiments, a threshold value could be defined such that a final score greater than the threshold value could be used to determine viewer V1 to be a master influencer with respect to the corresponding content type. In some embodiments, a threshold value could be defined such that a final score lower than the threshold value could be used to determine viewer V1 to be an unwelcome viewer with respect to the corresponding content type.

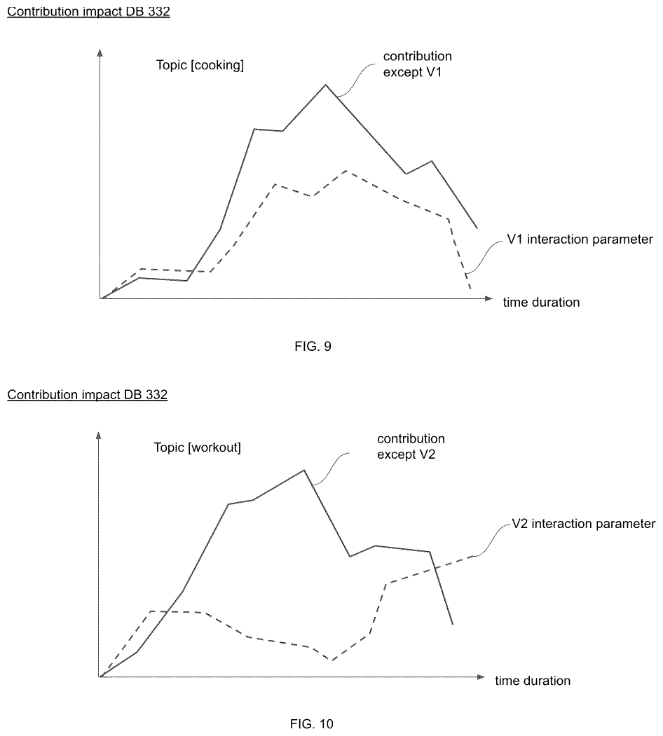

FIG. 9 shows an example of data stored in the contribution impact DB 332. As shown, under the topic [cooking], viewer V1's interaction parameter and the contribution except viewer V1 have similar trends. Therefore, viewer V1 could be determined to be a master influencer with respect to the topic [cooking].

FIG. 10 shows an example of data stored in the contribution impact DB 332. As shown, under the topic [workout], viewer V2's interaction parameter and the contribution except viewer V2 have opposite trends. Therefore, viewer V2 could be determined to be an unwelcome viewer with respect to the topic [workout].

The determining unit 324 is configured to determine a viewer to be a master influencer (or a helper viewer) with respect to a content type. The determination could be made according to the correlation values (or final scores) in the contribution impact DB 332, for example. The determining unit 324 may determine the viewer to have a positive impact on other viewers' contribution with respect to the content type according to interaction data of the viewer and contribution data of other viewers.

The determining unit 324 is configured to determine a distributor to have engaged in a specific content type in a stream (or live stream) performed by the distributor. In some embodiments, the determining unit 324 may refer to the interaction DB 330 for the content type of each stream. The content type could be updated or monitored in a real time manner.

The determining unit 324 is configured to suggest a distributor to invite a helper viewer into a stream performed by the distributor. The determining unit 324 may trigger the transmitting unit 332 to transmit the invitation message to the viewer.

The obtaining unit 320 is configured to obtain a request, from a distributor, to invite a viewer (such as a helper viewer with respect to an ongoing topic) into a stream (or live stream) performed by the distributor. The transmitting unit 322 is configured to transmit the request to the viewer. The obtaining unit 320 is configured to obtain, from the viewer, a selection result (such as an agreement or rejection to join the stream) with respect to the invitation request. If the selection result is agreement, the determining unit 324 may then invite the viewer into the stream, by triggering an inviting unit (not shown) within server 10, for example.

In some embodiments, the obtaining unit 320 may obtain a reward offer from the distributor to invite the viewer into the stream. The transmitting unit 322 may then transmit the reward offer to the viewer, for the viewer to decide whether or not to accept the invitation. A reward offer could be the gift, the points (or electronic money) used in the streaming platform. In some embodiments, the reward received by the invited viewer is deducted from the points of the inviting distributor.

In some embodiments, the determining unit 324 determines an interaction parameter in the stream (such as comment or gifting amount, for example) to be less than a threshold value, and then suggests the distributor to invite the viewer into the stream. The viewer is a master influencer in the corresponding topic and therefore could help encourage other viewers to contribute more to the distributor in the stream.

In some embodiments, once a viewer is determined to be a master influencer in a specific content type, the determining unit 324 may mark the viewer as the helper viewer with respect to the content type in a profile page of the viewer. In some embodiments, once a viewer is determined to be an unwelcome viewer in a specific content type, the determining unit 324 may mark the viewer as an unwelcome viewer with respect to the content type in a profile page of the viewer.

In some embodiments, a distributor may check a viewer's profile page to understand the viewer's impact on other viewers' contribution in different content types. For example, when the ongoing topic is [cooking], the distributor may want to invite a viewer who is a master influencer in [cooking] to help improve his/her achievement. For example, when the ongoing topic is [travel] and the distributor finds a newly joined viewer to be an unwelcome viewer in the topic [travel], the distributor may want to change topic in case his/her achievement is negatively affected by the viewer.

In some embodiments, a popular helper viewer may receive multiple invitations from different distributors. The viewer may choose whoever offers the highest reward to join or to help. For example, the obtaining unit 320 obtains a first request with a first reward offer to invite a viewer into a first live stream from a first distributor. The obtaining unit 320 obtains a second request with a second reward offer to invite the viewer into a second live stream from a second distributor. The transmitting unit 322 transmits the first request and the second request to the viewer. The viewer selects a live stream to join according to the reward offerings in the requests. The obtaining unit 320 obtains the selection result from the viewer. The determining unit 324 (or an inviting unit in server 10) then invites the viewer into the first live stream or the second live stream according to the selection result.

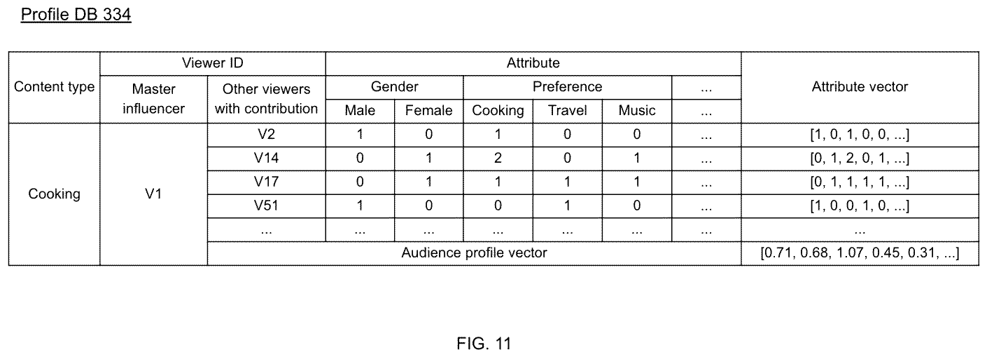

FIG. 11 is a data structure diagram showing an example of the profile DB 334 of FIG. 3. The profile DB 334 stores the content type, the viewer ID of the master influencer, the viewer IDs of other viewers, the attribute (or tag), the attribute vector, and the audience profile vector, in association with each other.

Data in the profile DB 334 could be derived from the contribution impact DB 332 and/or the interaction DB 330. For example, the obtaining unit 320 may identify, according to data in the interaction DB 330 and/or data in the contribution impact DB 332, the “other viewers” who contribute in the streams when viewer V1 was in those streams and when the topic was [cooking]. The obtaining unit 320 may then store those “other viewers” as “other viewers with contribution” in the profile DB 334.

When the “other viewers with contribution” are identified, the obtaining unit 320 may obtain their respective attribute data, from the user DB 312, for example. The attribute data could include data input by the viewer (such as gender) and/or data detected by a detecting unit within or outside server 10 (such as preference data, which could be detected according to historical comments of the viewer). In some embodiments, a value “1” means “yes” and a value “O” means “no”. In some embodiments, a value in the attribute data means the degree or the strength of the attribute. For example, viewer V14 has a higher value in the attribute [cooking], which means viewer V14 shows strong preference in the topic [cooking].

The attribute vector is a vector form of the attribute data. The audience profile vector is an average of the attribute vectors, and could be viewed as the profile vector for those “other viewers with contribution” for viewer V1 under the topic [cooking].

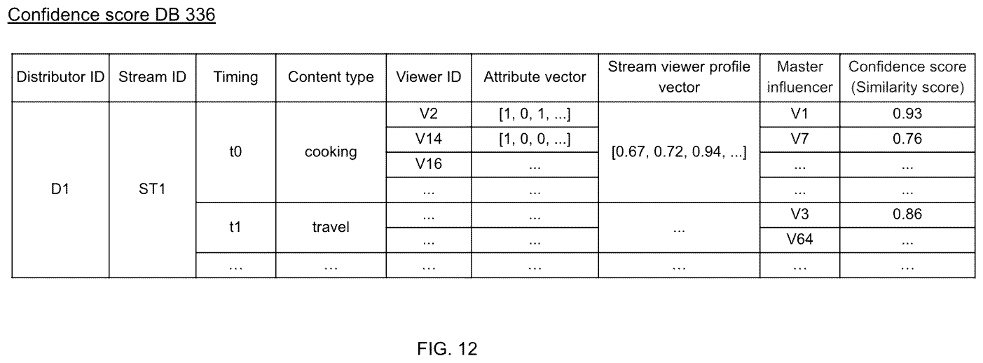

FIG. 12 is a data structure diagram showing an example of the confidence score DB 336 of FIG. 3. The confidence score DB 336 stores the distributor ID, the stream ID, the timing, the content type, the viewer ID, the attribute vector, the stream viewer profile vector, the master influencer, and the confidence score (or similarity score), in association with each other. In some embodiment, as the time goes by (t0, t1, t2, . . . ), the data in the confidence score DB 336 is stored, updated and/or calculated in a real time manner.

The viewer ID stores the viewers in the stream ST1 at the corresponding timing (or time span). Each viewer's attribute vector is obtained and stored, by the obtaining unit 320, for example.

The stream viewer profile vector is calculated from the attribute vectors of all the viewers at the corresponding timing, and an average calculation could be used, for example. In some embodiments, the calculation for the stream viewer profile vector is the same as the calculation for the audience profile vector in the profile DB 334. The stream viewer profile vector could be calculated in a real time manner for each timing.

The master influencer stores the viewers (or helper viewers) who have high impacts (or positive impacts) on other viewers' contributions with respect to the corresponding content type. The helper viewers could be identified from the contribution impact DB 332, for example.

The confidence score is calculated according to the stream viewer profile vector and the audience profile vector of the master influencer with respect to the corresponding content type (in the profile DB 334). A similarity calculation between vectors could be utilized. A normalization calculation could be involved. The higher the confidence score, the more similar between the stream viewer profile vector (at the corresponding timing) and the audience profile vector (in the profile DB 334) of the master influencer. Therefore, the higher the confidence score, the corresponding master influencer could be recommended with a higher precision, and the expected effectiveness could be higher. That is, the master influencer could have a higher possibility of helping the distributor improve his/her achievement. In some embodiments, the confidence score is determined according to attributes of other viewers in previous streams engaged by the helper viewer and attributes of other viewers in the currently ongoing live stream performed by the distributor.

In some embodiments, when the determining unit 324 suggests a distributor to invite a viewer into the stream, the determining unit 324 provides the confidence score of determining the viewer to be the helper viewer with respect to the content type to the distributor. Therefore, the distributor can determine whether or not to invite the helper viewer accordingly. Or, the distributor may determine the reward offer to invite the helper viewer according to the confidence score.

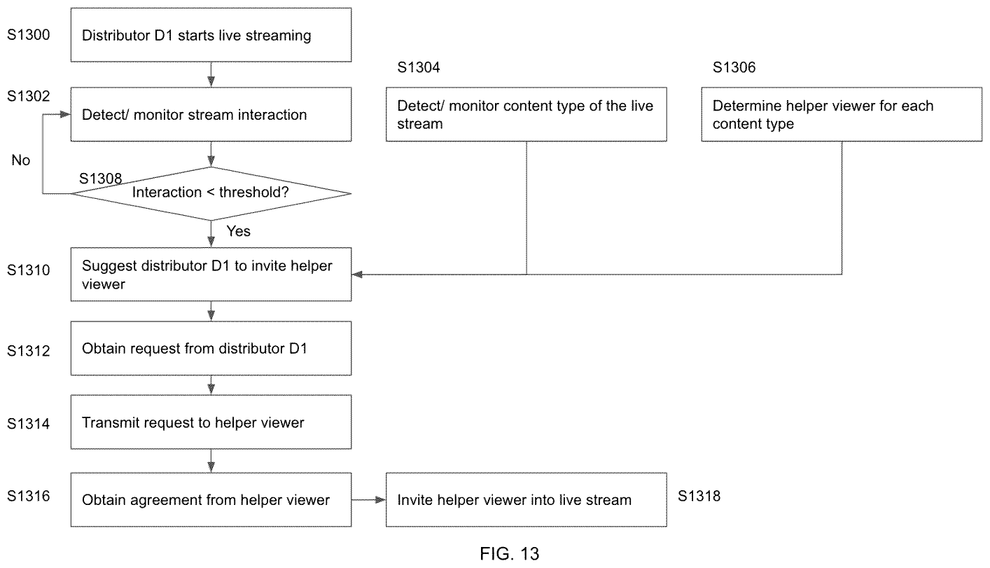

FIG. 13 shows an exemplary flow according to some embodiments of the present disclosure.

At step S1300, distributor D1 starts a live stream.

At step S1302, interaction parameters (such as comment number, gifting number, viewer number) in the live stream are detected or monitored.

At step S1304, the content type of the live stream is detected or monitored.

At step S1306, the helper viewer for each content type is determined according to methods described above.

At step S1308, the determining unit 324 determines if the interaction parameter(s) is below a threshold value. If yes, the flow goes to step S1310. If not, the flow goes back to step S1302.

At step S1310, the determining unit 324 suggests distributor D1 to invite a helper viewer with respect to the current content type of the live stream. The determining unit 324 may trigger the server 10 to transmit information of the helper viewer to distributor D1.

At step S1312, the obtaining unit 320 obtains a request to invite the helper viewer into the live stream from distributor D1.

At step S1314, the transmitting unit 322 transmits the request to the helper viewer.

At step S1316, the obtaining unit 320 obtains an agreement to join the live stream from the helper viewer.

At step S1318, the determining unit 324 (or server 10) invites the helper viewer into the live stream.

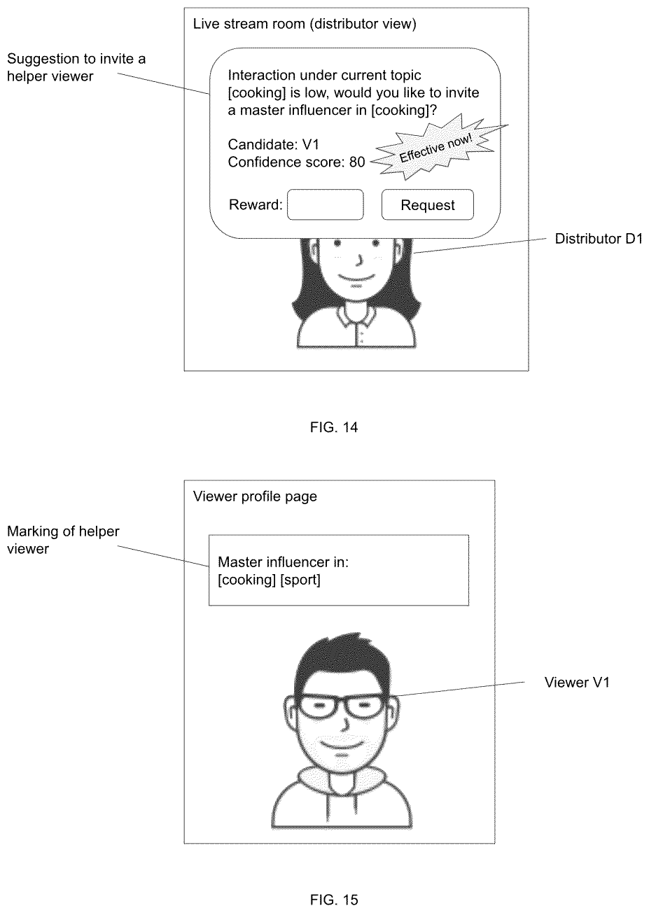

FIG. 14 shows an exemplary user interface at the distributor side according to some embodiments of the present disclosure. As shown, a suggestion to invite helper viewer V1 is displayed to distributor D1. The confidence score of the recommendation is also provided for distributor D1's reference. Distributor D1 may input a reward offer and send out the invitation request.

FIG. 15 shows an exemplary viewer profile page according to some embodiments of the present disclosure. As shown, viewer V1 is marked as the master influencer (or helper viewer) in the content types [cooking] and [sport].

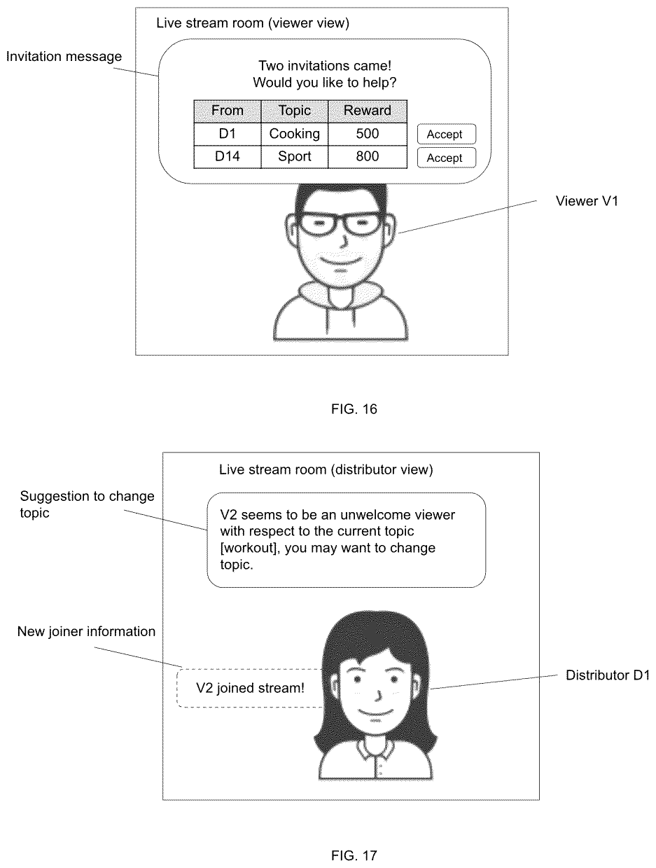

FIG. 16 shows an exemplary user interface at the viewer side according to some embodiments of the present disclosure. As shown, the helper viewer V1 receives invitations from two distributors. Viewer V1 may choose one to accept according to the distributor, the topic or the reward.

FIG. 17 shows an exemplary user interface at the distributor side according to some embodiments of the present disclosure. As shown, if viewer V2 is an unwelcome viewer with respect to the topic [workout] and the current topic in the stream room is [workout], a suggestion message (to change topic, for example) is displayed to the distributor when viewer V2 joins the stream.

In some embodiments, the live streaming platform can provide a virtual character to serve as the master influencer. The virtual character may learn, by a machine learning model, the interaction pattern of a viewer who is a master influencer with respect to a specific content type. A viewer may pay points or use gifts to invite the virtual character to join a live stream to help support the distributor. The virtual character can join a chat room to interact (such as comment or talk) with the distributor, and to motivate other viewers to contribute. The virtual character may learn different interaction patterns from different helper viewers, and may behave (such as comment or talk) according to those patterns with respect to different content types. The virtual character may join different chat rooms concurrently and behave in a different way according to the content types in those chat rooms. The virtual character may refer to the viewer profile of a chat room, and behave in a pattern that can maximize the contribution from the viewers of the chat room.

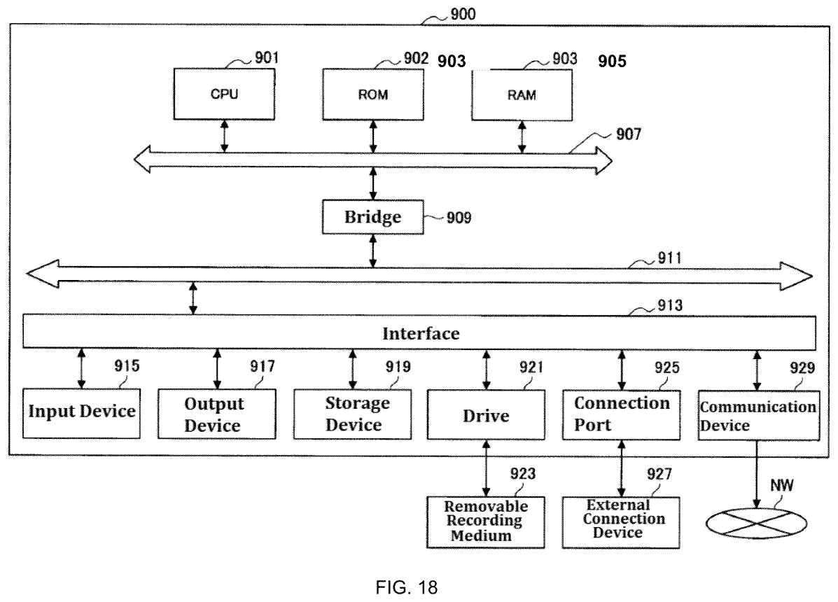

Referring to FIG. 18, the hardware configuration of the information processing device will be now described. FIG. 18 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

What is claimed is:

1. A method for stream distribution, executed by a server, comprising:
determining a viewer to be a helper viewer with respect to a content type;
determining a distributor to have engaged in the content type in a stream; and
suggesting the distributor to invite the viewer into the stream.

2. The method according to claim 1, wherein the determining the viewer to be the helper viewer with respect to the content type comprises:
determining the viewer to have a positive impact on another viewer's contribution with respect to the content type according to interaction data of the viewer and contribution data of the another viewer.

3. The method according to claim 1, further comprising:
obtaining a request to invite the viewer into the stream from the distributor;
transmitting the request to the viewer;
obtaining an agreement to join the stream from the viewer; and
inviting the viewer into the stream.

4. The method according to claim 1, further comprising:
obtaining a reward offer from the distributor to invite the viewer into the stream; and
transmitting the reward offer to the viewer.

5. The method according to claim 1, further comprising:
determining an interaction parameter in the stream to be less than a threshold value before suggesting the distributor to invite the viewer into the stream.

6. The method according to claim 5, wherein the stream is a live stream, and the interaction parameter is real time comment number or real time gifting number in the stream.

7. The method according to claim 1, further comprising:
marking the viewer as the helper viewer with respect to the content type in a profile page of the viewer.

8. The method according to claim 1, further comprising:
providing a confidence score of determining the viewer to be the helper viewer with respect to the content type to the distributor,
wherein the confidence score is determined according to attributes of other viewers in previous streams engaged by the viewer and attributes of other viewers in the stream.

9. A method for live stream distribution, executed by a server, comprising:
obtaining a first request with a first reward offer to invite a viewer into a first live stream from a first distributor;
obtaining a second request with a second reward offer to invite the viewer into a second live stream from a second distributor;
transmitting the first request and the second request to the viewer;
obtaining a selection result from the viewer; and
inviting the viewer into the first live stream or the second live stream according to the selection result.

10. A system for stream distribution, comprising one or a plurality of processors, wherein the one or plurality of processors execute a machine-readable instruction to perform:
determining a viewer to be a helper viewer with respect to a content type;
determining a distributor to have engaged in the content type in a stream; and
suggesting the distributor to invite the viewer into the stream.
